(19) United States
(12) Patent Application Publication
(10) Pub. No.: US 2026/0340904 A1
(43) Pub. Date: Oct. 29, 2026

(54) STORAGE MEDIUM STORING PROGRAM FOR GENERATING LAYOUT OF CONTENTS, INFORMATION PROCESSING APPARATUS, AND INFORMATION PROCESSING METHOD

(71) Applicant: CANON KABUSHIKI KAISHA, Tokyo (JP)

(72) Inventor: YOSHINORI HASHIMOTO, Kanagawa (JP)

(21) Appl. No.: 19/655,477

(22) Filed: Apr. 22, 2026

(30) Foreign Application Priority Data
Apr. 25, 2025 (JP) 2025-073760

(51) Int. Cl. G06T 11/60; G06F 3/0482; G06F 3/04845

(52) U.S. Cl. CPC G06T 11/60; G06F 3/0482; G06F 3/04845

(57) ABSTRACT

To increase the degree of freedom at the time of editing by a user in a layout design of contents and to thus improve the convenience. The present disclosure causes a display device to display a plurality of first layout proposals relating to the contents, receives a user instruction of selecting a specific object among objects included in each of the plurality of first layout proposals, and generates a second layout proposal of the contents based on the selected object.

### BACKGROUND

### Field of the Technology

The present disclosure relates to a technology for generating a layout of contents.

### Description of the Related Art

In recent years, applications for generating contents such as posters and flyers have been widely used. In such a contents generating application, a technology which displays a plurality of layout proposals in which sizes and arrangement of objects such as an image, an illustration, and a text are different, and receives a user selection of a desired layout has been known (see Japanese Patent Laid-Open No. 2024-11650).

In the case of designing a layout of contents, there is a case where a user, for example, wants to select a specific layout proposal from a plurality of layout proposals which are initially generated by a generative AI or prepared in advance, and further edit the specific layout proposal to determine a layout design. In this event, there can also be a case where the user wants to further combine and edit an image, a text, or the like present only in unselected layout proposals.

### SUMMARY

The present disclosure has been made in view of the above-described problem, and an object of the present disclosure is to increase the degree of freedom at the time of editing by a user in a layout design of contents and to thus improve the convenience.

A non-transitory computer readable storage medium according to the present disclosure is a non-transitory computer readable storage medium storing a program for causing a computer to generate a layout of contents by executing the following processing:
causing a display device to display a plurality of first layout proposals relating to the contents;
receiving a user selection for a specific object from among objects included in each of the plurality of first layout proposals; and
generating a second layout proposal of the contents based on the specific object according to the user selection.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram showing an example of a configuration of an information processing system;

FIG. 2 is a diagram showing an example of a hardware configuration of an information processing apparatus;

FIG. 3 is a flowchart showing an operation of a Web application according to Embodiment 1;

FIG. 4A is a diagram showing an example of a UI screen;

FIG. 4B is a diagram showing an example of a UI screen;

FIG. 4C is a diagram showing an example of a UI screen;

FIG. 4D is a diagram showing an example of a UI screen;

FIG. 4E is a diagram showing an example of a UI screen;

FIG. 5 is a flowchart showing a detail of layout proposal regeneration processing according to Embodiment 1;

FIG. 6A is a diagram showing an example of a UI screen;

FIG. 6B is a diagram showing an example of a UI screen;

FIG. 6C is a diagram showing an example of a UI screen;

FIG. 6D is a diagram showing an example of a UI screen;

FIG. 7 is a flowchart showing a detail of layout proposal regeneration processing according to Embodiment 2;

FIG. 8A is a diagram showing an example of a UI screen;

FIG. 8B is a diagram showing an example of a UI screen;

FIG. 8C is a diagram showing an example of a UI screen;

FIG. 8D is a diagram showing an example of a UI screen;

FIG. 8E is a diagram showing an example of a UI screen;

FIG. 9 is a flowchart showing a detail of layout proposal regeneration processing according to Embodiment 3;

FIG. 10A is a diagram showing an example of a UI screen;

FIG. 10B is a diagram showing an example of a UI screen;

FIG. 10C is a diagram showing an example of a UI screen;

FIG. 10D is a diagram showing an example of a UI screen;

FIG. 10E is a diagram showing an example of a UI screen;

FIG. 11 is a diagram showing an example of an object table;

FIG. 12 is a flowchart showing a detail of layout proposal regeneration processing according to Embodiment 4;

FIG. 13A is a diagram showing an example of a UI screen;

FIG. 13B is a diagram showing an example of a UI screen;

FIG. 13C is a diagram showing an example of a UI screen;

FIG. 13D is a diagram showing an example of a UI screen;

FIG. 13E is a diagram showing an example of a UI screen;

FIG. 13F is a diagram showing an example of a UI screen;

FIG. 13G is a diagram showing an example of a UI screen;

FIG. 13H is a diagram showing an example of a UI screen; and

FIG. 13I is a diagram showing an example of a UI screen.

### DESCRIPTION OF THE EMBODIMENTS

Hereinafter, with reference to the attached drawings, the present disclosure is explained in detail in accordance with preferred embodiments. Configurations shown in the following embodiments are merely exemplary and the present disclosure is not limited to the configurations shown schematically.

### FIRST EMBODIMENT

### System Configuration

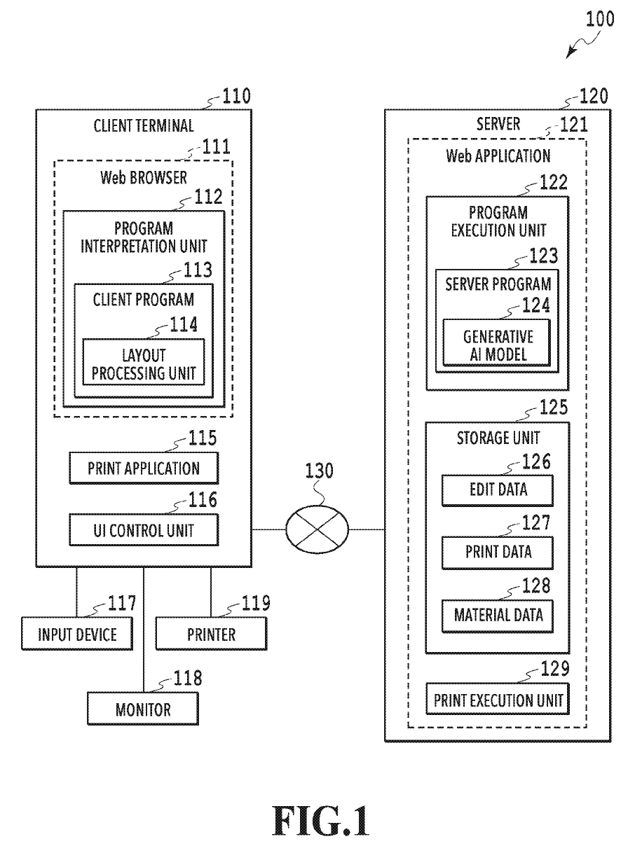

FIG. 1 is a diagram showing an example of a configuration of an information processing system according to the present disclosure. An information processing system 100 operates with a client terminal 110 and a server 120 cooperating with each other via a network 130.

First of all, a configuration of the server 120 will be described. The server 120 provides a Web application 121. The Web application 121 is configured with a program execution unit 122, a storage unit 125, and a print execution unit 129. The program execution unit 122 executes a server program 123 which is a program to be operated in the server 120. The storage unit 125 stores image files, edit data 126, print data 127, material data 128, and the like which are used in the Web application 121. The material data 128 contains data of various templates prepared in advance, layout proposals generated by a generative AI model 124, and various objects included in the layout proposals, and the like. The print execution unit 129 transmits the print data 127 to the print application 115 and performs printing.

Next, a configuration of the client terminal 110 will be described. The client terminal 110 is, for example, a general personal computer or smartphone, and includes a Web browser 111, a print application 115, and a UI control unit 116. The Web browser 111 browses a Website on the Internet and executes the Web application 121. The Web application 121 is generally configured with a client program 113 and a server program 123. The entity of the client program 113 is a program of Hypertext Markup Language (HTML), JavaScript, or the like, or the like which operates on the Web browser 111. The entity of the server program 123 is a program which operates on the server 120. In the case of executing the Web application 121, the client terminal 110 first receives, from the server 120, the client program 113, which configures part of the Web application 121. Subsequently, the Web browser 111 interprets and executes the client program 113 (a script language such as HTML or JavaScript), so that the Web application 121 is activated. More specifically, once a URL is inputted into the Web browser 111, the server 120 transmits, to the Web browser 111, the client program 113, which configures part of the Web application 121. Subsequently, the Web browser 111 receives the client program 113, and a program interpretation unit 112 executes the client program 113, so that the Web application 121 is activated. Note that the client program 113 includes a layout processing unit 114. The layout processing unit 114 receives an input of a prompt by the user, and performs automatic generation of a layout and the like of target contents by using the generative AI (Artificial Intelligence) model 124 of the server program 123. Data of the layout and the like (products) generated by the generative AI model 124 is stored in the storage unit 125 as material data 128, and is also transmitted to the client terminal 110 and displayed in a user interface screen (UI screen) of the client terminal 110. The print application 115 receives the print data 127 from the server 120, and causes a printer 119, which is connected to the client terminal 110 directly (or via the network 130), to execute print processing.

The printer 119 executes print processing based on print data received via the print application 115. The input device 117 is an input device such as a keyboard or pointing device for the user to perform an input operation into the information processing system 100. The monitor 118 is a display device for displaying image information of a UI screen and the like outputted by the UI control unit 116. The input device 117 may be a touch panel which is integrated with the monitor 118 and allows input through direct touch on the monitor 118.

Note that the system configuration shown in FIG. 1 is an example, and the configuration is not limited to this. For example, the program execution unit 122, the storage unit 125, and the print execution unit 129 included in the Web application 121 may be implemented respectively in separate server apparatuses. In addition, for example, the client terminal 110 may be configured to include the input device 117 and the monitor 118. Moreover, the present disclosure can also be applied to an integrated information processing apparatus having both client function and server function, that is, an information processing apparatus equipped with a function of a generative AI service which is provided by the server 120.

### Hardware Configuration

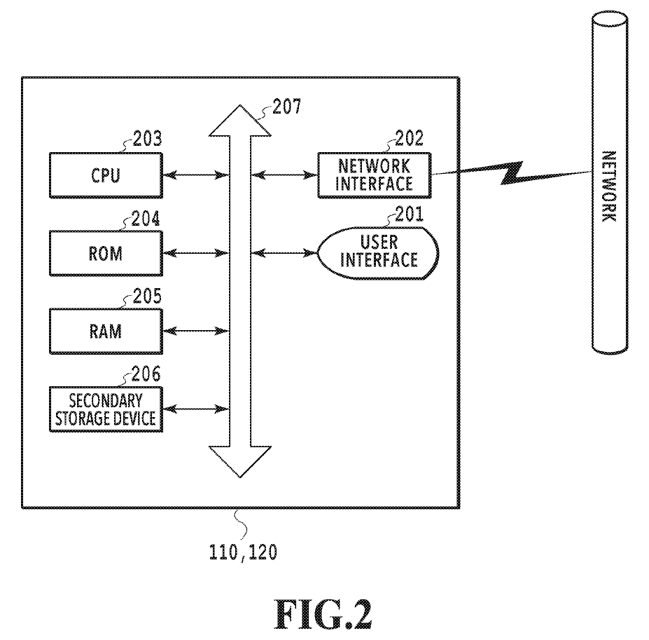

FIG. 2 is a diagram showing an example of a hardware configuration of an information processing apparatus which is common to the client terminal 110 and the server 120. A user interface 201 is an interface via which to input and output information with a user for causing the monitor 118 to display a UI screen and for receiving a user operation via the input device 117 such as a mouse or a keyboard. A network interface 202 is connected to the network 130, and establishes communications with the server 120 and other network devices. The method for the communication may be wired or wireless. A CPU 203 is a central processing unit which executes programs read from a ROM 204, a RAM 205, a secondary storage device 206, and the like. The ROM 204 is a non-volatile memory in which built-in programs and data are recorded. The RAM 205 is a volatile memory which provides a temporary memory area. The secondary storage device 206 is a large-capacity storage device represented by an HDD or a flash memory. It is also possible to connect and operate a computer which does not include these pieces of hardware from another computer by means of remote desktop, remote shell, or the like. These units are connected via an input-output interface 207.

### Web Application

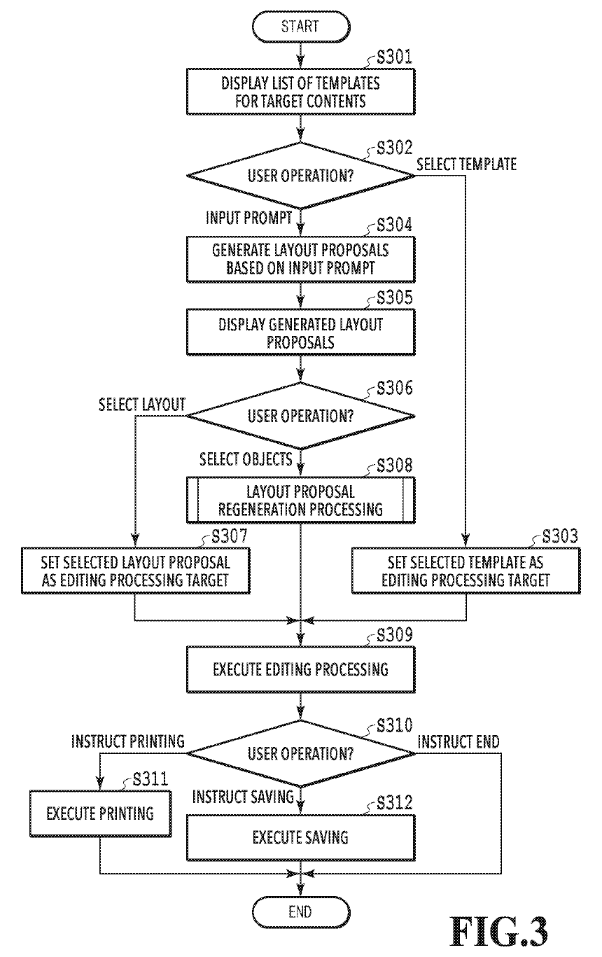

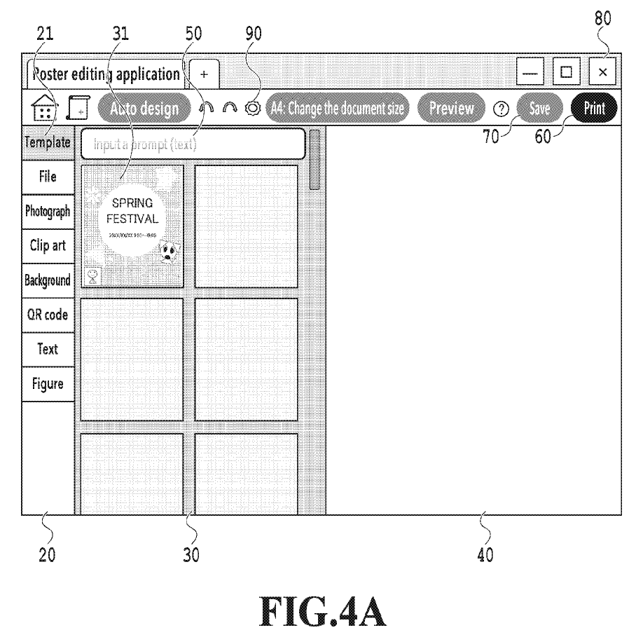

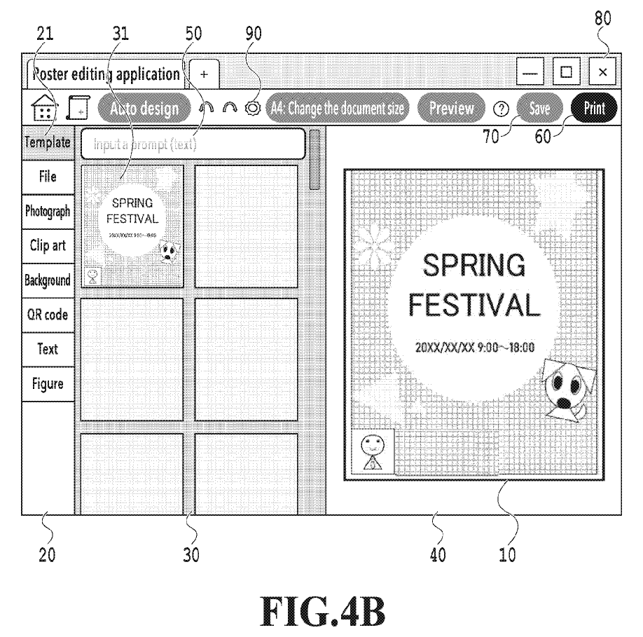

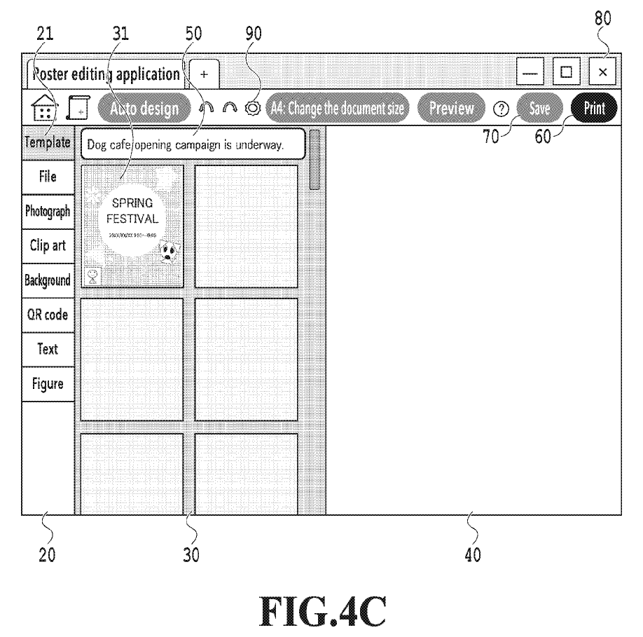

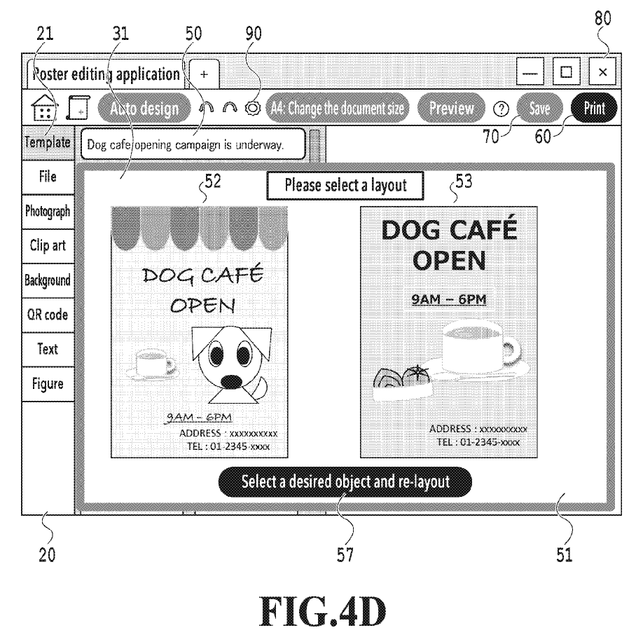

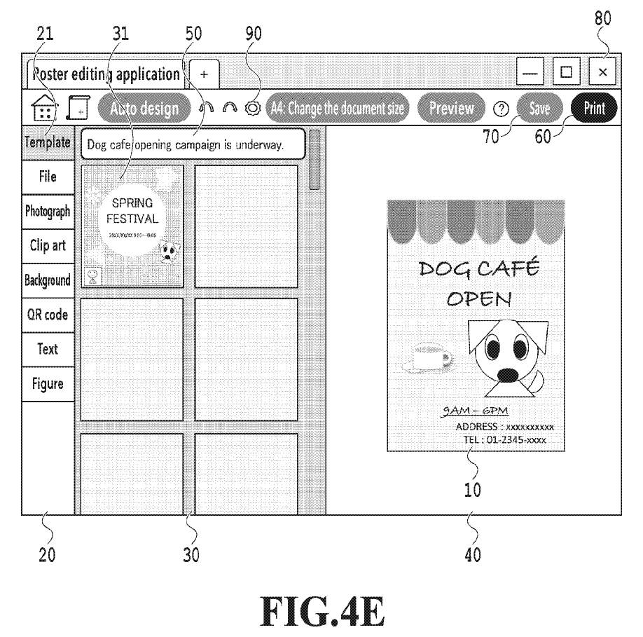

Subsequently, an operation of the Web application 121 will be described by using a flowchart of FIG. 3 and examples of UI screens of FIGS. 4A to 4E. In the present embodiment, a poster editing application will be described as an example, but the Web application 121 is not limited to a poster editing application. For example, the present disclosure can be applied to various general pieces of application software which deal with a layout of contents, such as a photo album editing application.

Once the user activates the Web application 121, a series of processings shown in the flowchart of FIG. 3 is started. Each step of the flowchart of FIG. 3 is implemented by the CPU 203 reading out a predetermined program from the ROM 204 or the like, deploying the predetermined program onto the RAM 205, and executing the predetermined program. Note that in the following description, sign "S" means a step.

First, in S301, the CPU 203 displays, based on a selecting operation of the user, a list of templates corresponding to the kind of contents to be generated. The template is a layout proposal prepared in advance, and is prepared in advance for each kind of contents such as a poster, a flyer, or a calendar, and is held as the material data 128. The CPU 203 displays a UI screen shown in FIG. 4A on the monitor 118 via the UI control unit 116. The UI screen of FIG. 4A is configured with a category selection area 20, a template selection area 30, an editing area 40, a prompt entry field 50, and the like. For example, in a case where the user selects "poster" as target contents, and presses down a template selection button 21 in the category selection area 20, the CPU 203 displays, in the template selection area 30, a list of templates for a poster, which are prepared in advance.

In S302, the CPU 203 monitors a user operation on the displayed UI screen, and switches processing to be executed next based on a detected user operation. Specifically, in a case where the detected user operation is an operation (for example, mouseover+click) of selecting a specific template in the template selection area 30, the CPU 203 proceeds to S303. On the other hand, in a case where the detected user operation is not an operation of selecting a specific template in the template selection area 30, but an operation of inputting a prompt (text) into the prompt entry field 50, the CPU 203 proceeds to S304.

In S303, the CPU 203 sets a layout as an editing processing target based on the template according to the user selection. Specifically, the CPU 203 obtains, from the server 120, data of the template according to the user selection, and displays the template in the editing area 40 as a layout 10 of the editing target. FIG. 4B shows a UI screen in a case where the user has performed an operation of selecting a template 31 from the template selection area 30, and the UI screen transitions from the state of FIG. 4A to such a UI screen. In the UI screen of FIG. 4B, a layout 10 corresponding to the template 31 according to the user selection is displayed in the editing area 40. After the processing of S303 ends, the CPU 203 proceeds to S309.

In S304, the CPU 203 generates a layout proposal using the generative AI model 124 based on the input prompt. FIG. 4C is an example of a UI screen in a case where a character string (text) "Dog cafe opening campaign is underway." has been inputted into the prompt entry field 50 in order to generate a layout for an opening campaign of a dog cafe. In the state of the UI screen of FIG. 4C, for example, in a case where it is detected that the Enter key of the keyboard is pressed down, the CPU 203 transmits, as an input prompt, the text inputted into the prompt entry field 50 to the server 120 implemented with an AI image generator such as "Stable Diffusion", for example, to make a request for generating a poster layout. Note that in the present embodiment, the input prompt is English text input, but may be, for example, Japanese text input, and the used language is not limited. Upon receipt of this generation request, the server 120 generates, by using the generative AI model 124, a layout proposal based on the input prompt contained in the generation request, and returns data of the layout proposal to the client terminal 110.

In S305, the CPU 203 receives the data of the layout proposal generated by the generative AI model 124 from the server 120, and displays the layout proposal on the UI screen. In this way, the UI screen transitions from the state of FIG. 4C to the state of FIG. 4D. Now, in a UI screen of FIG. 4D, two kinds of layout proposals 52 and 53 generated by the generative AI model 124 are displayed in a display area 51. In addition, in the upper portion of the display area 51, a message which prompts selecting a layout is displayed, and in the lower portion of the display area 51, a button 57 for generating a new layout proposal by using objects such as images and texts which are included in the plurality of layout proposals in the display area 51 is displayed. Note that here, an example of the case where two layout proposals are generated is shown for convenience of the description, the number of layout proposals to be generated by the generative AI and the number of layout proposals to be displayed are not limited to this.

In S306, the CPU 203 switches processing to be executed next based on a user operation on the displayed UI screen. Specifically, in a case where the detected user operation is an operation (for example, mouseover+click on a target layout proposal) of selecting a specific layout proposal among the plurality of layout proposals in the display area 51, the CPU 203 proceeds to S307. On the other hand, in a case where the detected user operation is not an operation of selecting a specific layout proposal, but is the pressing down of the button 57, the CPU 203 proceeds to S308. Now, in the UI screen of FIG. 4D, in a case where an operation of selecting any layout proposal is detected, the CPU 203 proceeds to S307, and in a case where an operation of selecting the "Select a desired object and re-layout" button 57 is detected, the CPU 203 proceeds to S308.

In S307, the CPU 203 sets the layout proposal according to the user selection as an editing processing target. Specifically, the CPU 203 displays the layout proposal according to the user selection in the editing area 40. FIG. 4E shows a UI screen in a case where the user has selected the layout proposal 52, and the UI screen transitions from the state of FIG. 4D to such a UI screen. After the processing of S307 ends, the CPU 203 proceeds to S309.

In S308, the CPU 203 performs processing of regenerating a new layout proposal based on an object (hereinafter, referred to as a "selected object") according to the user selection. A detail of this layout proposal regeneration processing will be described later. After the processing of S308 ends, the CPU 203 proceeds to S309.

In S309, the CPU 203 executes the editing processing of the layout based on an editing operation by the user. Specific examples of the editing operation include addition, movement, size change, color change, and the like of an object. After the processing of S309 ends, the CPU 203 proceeds to S310.

In S310, the CPU 203 switches processing to be executed next based on a user operation on the displayed UI screen. Specifically, in a case where the detected user operation is the pressing down of a print button 60, the CPU 203 proceeds to S311, and in a case where the detected user operation is the pressing down of a save button 70, the CPU 203 proceeds to S312. On the other hand, in a case where the detected user operation is the pressing down of an end button 80, the CPU 203 ends the editing processing.

In S311, the CPU 203 causes, via the print application 115, the printer 119 to executes print processing based on poster data after the editing processing. In S312, the CPU 203 saves data of a layout after the editing processing in the secondary storage device 206 or the like as poster data. After the processing of any of S311 and S312 ends, the CPU 203 ends the operation of the Web application 121.

The above is the overview of the operation of the Web application 121. Note that an environment setting button 90 in FIGS. 4A to 4E is a button for the user to switch a display in performing the editing work in accordance with the user's preference. Examples of the environment setting include a display setting of a trimming area, a display setting of a grid or guide line which roughly indicates the arrangement in the editing area 40, and the like.

### Detail of Layout Proposal Regeneration Processing

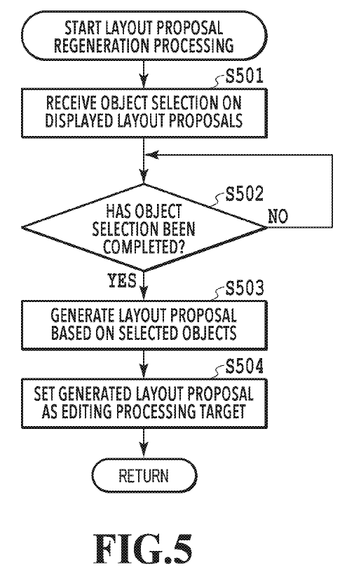

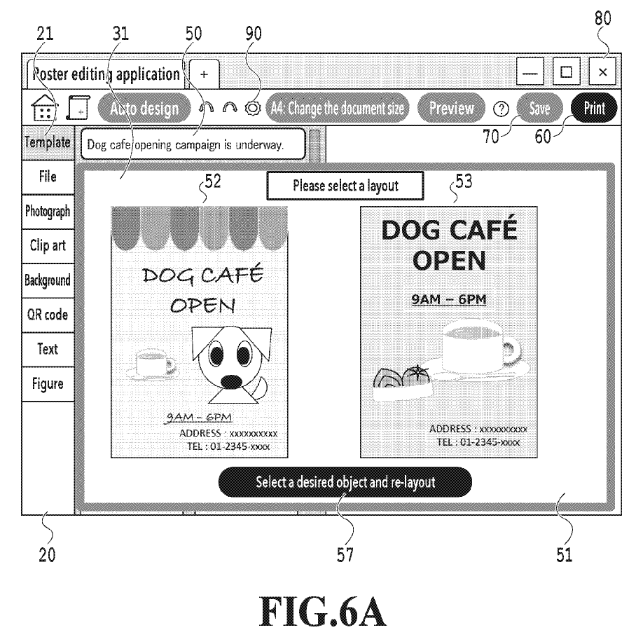

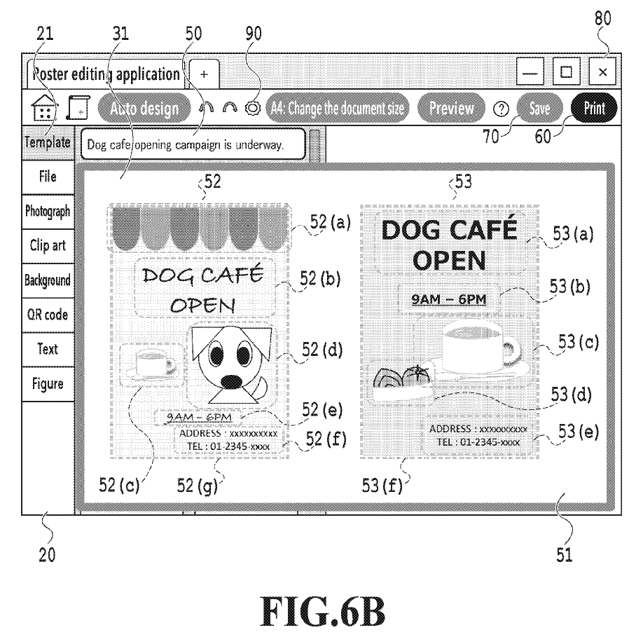

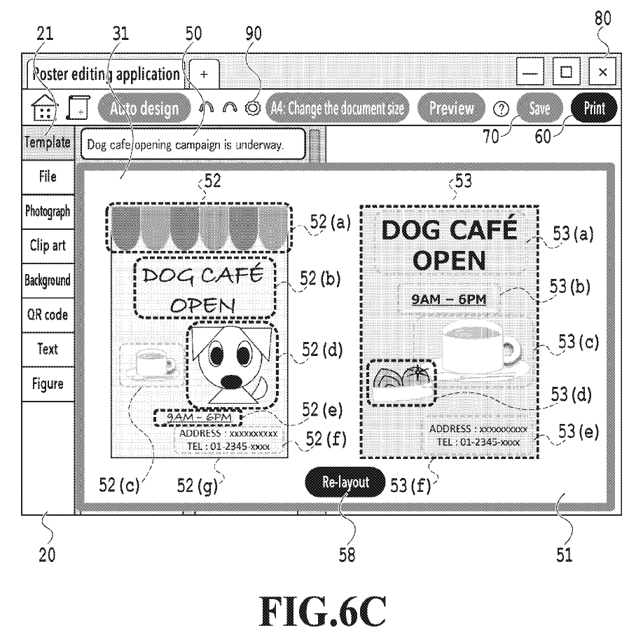

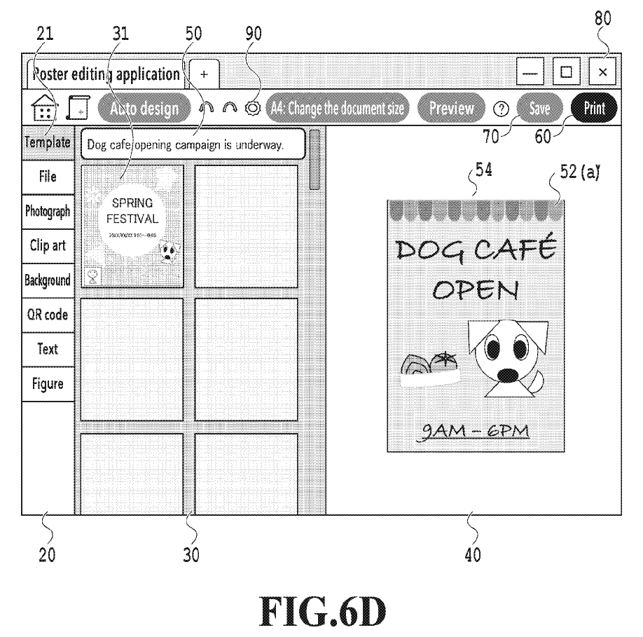

Subsequently, regeneration of a layout proposal based on an object selected by the user, which is a feature of the present embodiment will be described by using a flowchart of FIG. 5 and examples of UI screens of FIGS. 6A to 6D. In the present embodiment, a user selection for an object present in a plurality of layout proposals is received, and a new layout proposal based on the object (selected object) according to the user selection is generated by the generative AI model 124, and is presented as a layout proposal of the editing target to the user. Here, as shown in FIG. 6A, a case where two kinds of layout proposals, which were generated by the generative AI model 124 with "Dog cafe opening campaign is underway." as an input prompt, have been initially generated will be described as an example. The processing of the flowchart of FIG. 5 is started in response to the pressing down of the "Select a desired object and re-layout" button 57 by the user in a UI screen of FIG. 6A. Note that in the following description, sign "S" means a step.

In S501, the CPU 203 displays each object in a recognizable manner by applying a known image analysis technology to each displayed layout proposal, and so on, and receives a user selection on an object basis. FIG. 6B is a UI screen in which objects included in the layout proposals 52 and 53 in the display area 51 of FIG. 6A are indicated with boundary frames of dashed lines (52(a) to 52(g) and 53(a) to 53(f)) such that the user can recognize the respective objects. The user selects the objects 52(a) to 52(g) and 53(a) to 53(f) on an object basis via the UI screen in which each object can be recognized as shown in FIG. 6B. In this event, a selected object may be highlighted such that the user can grasp which object the user has selected. Note that the user can release the selection by performing the selecting operation again on the selected object. FIG. 6C shows a UI screen in a case where the objects 52(a), 52(b), 52(d), and 52(e) have been selected from the layout proposal 52 and the objects 53(d) and 53(f) have been selected from the layout proposal 53. In a case where the user selects any objects via the input device 117 in this way, a "Re-layout" button 58 is displayed in the lower portion of the display area 51. This "Re-layout" button 58 is a button for the user to instruct generation of a new layout proposal based on the objects according to the selection at a stage where the user has completed the selection of desired objects. Note that in place of the approach for selecting objects as mentioned above, objects may be selected by a clipping operation of designating any area in a layout proposal, for example.

In S502, the CPU 203 determines whether the user selection for desired objects has been completed. Specifically, the CPU 203 periodically checks the pressing down of the aforementioned "Re-layout" button 58, and proceeds to S503 at the timing at which the pressing down is detected. That is, until the pressing down of the "Re-layout" button 58 is detected, the CPU 203 returns to S501 and continues the processing of receiving the selection of an object.

In S503, the CPU 203 generates a new layout proposal based on all the objects selected by the user. The processing of the present step is basically the same as aforementioned S304, and a request for generating a new layout proposal using the selected objects is transmitted to the server 120. Specifically, the CPU 203 transmits an input prompt such as "Create a new layout using the selected objects.", for example, to the server 120. Note that the CPU 203 may generate a new layout proposal using a known technology as disclosed in Japanese Patent Laid-Open No. 2024-11650, for example, by itself or via an external apparatus without using a generative AI. In addition, in the generation of a new layout proposal, adjustment processing of making expansion, contraction, or the like of an object may be performed as necessary in conformity to a framework of the new layout proposal to be generated, such as a balance between objects.

In S504, the CPU 203 sets, as an editing processing target, the layout proposal newly generated in S503. Specifically, as shown in FIG. 6D, the CPU 203 displays the generated new layout proposal 54 in the editing area 40 on the UI screen, and receives subsequent editing processing by the user. Note that in the UI screen of FIG. 6D, the image object 52(a) selected from the layout proposal 52 has been resized to be smaller by the adjustment processing in conformity to the framework of the new layout proposal 54 (see an object 52(a')). After setting the layout proposal to be used as the editing processing target, the CPU 203 exits the present processing, and returns to the flowchart of FIG. 3. The above is the content of the layout proposal regeneration processing according to the present embodiment.

### Modification

Note that in the above-mentioned embodiment, a new layout proposal is regenerated by using objects selected from the layout proposals initially generated by the generative AI; however, the configuration is not limited to this. For example, a new layout proposal may be regenerated by using objects selected from a template group included in an application in advance. Specifically, a user selection of desired objects from a list of templates may be received to generate a new layout proposal based on the objects according to the user selection. That is, a configuration may be employed in which the user selects desired objects from a plurality of layout proposals which differ from each other in kinds, positions, sizes, colors, and the like of objects, and generate a new layout based on the selected objects. The target on which the user performs the object selection may be a layout proposal generated by a generative AI, or may be a template prepared in advance, or may be a combination of these. In addition, objects to be used in the layout proposal regeneration processing does not necessarily have to be those selected from a plurality of layout proposals. For example, data of images and texts which were used in layouts of various contents generated by the user by using another application or the like in the past may be read out and applied, or objects generated separately by a generative AI may be applied.

As described above, according to the present embodiment, it becomes possible to receive selection of objects from a plurality of layout proposals by the user, and generate a new layout proposal including the selected objects. In this way, a user convenience in layout design of contents is improved.

### SECOND EMBODIMENT

In Embodiment 1, a new layout proposal generated based on objects selected by the user is set as an editing target. Next, an aspect to present a new layout proposal based on selected objects to the user, ask the user to check whether to employ the new layout proposal, and repeat regeneration of a new layout as necessary will be described as Embodiment 2. Note that in the following description, the description of contents common with the aforementioned Embodiment 1 will be omitted, and layout proposal regeneration processing which is a difference from Embodiment 1 will be described. In addition, in terms of the same configurations as in Embodiment 1, the same signs are added, or the same names are used, so that the description thereof is omitted as appropriate.

### Detail of Layout Proposal Regeneration Processing

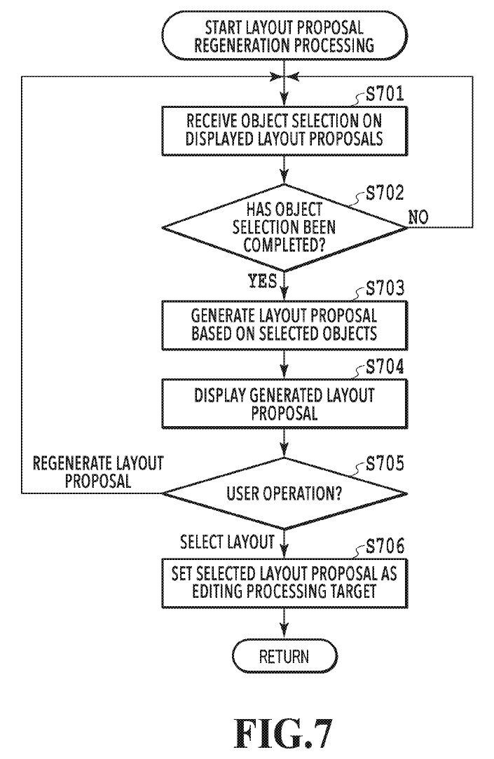

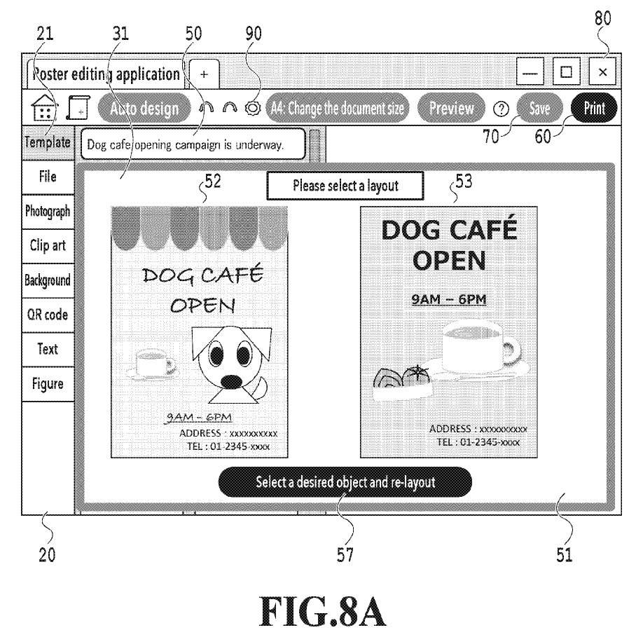

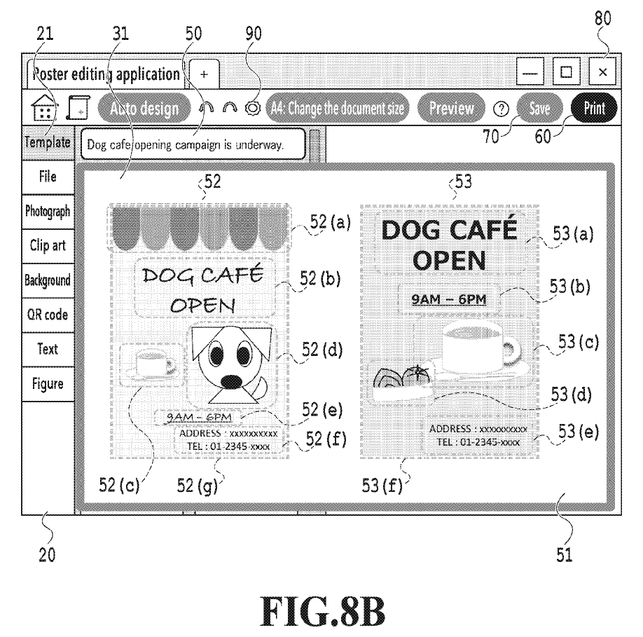

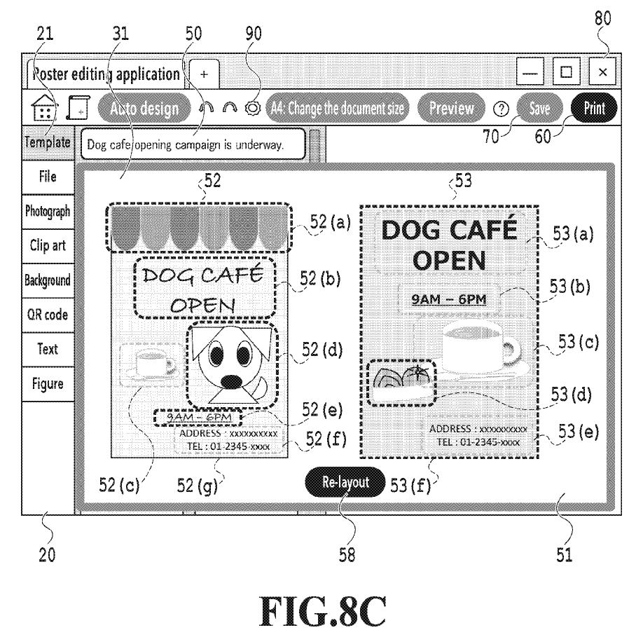

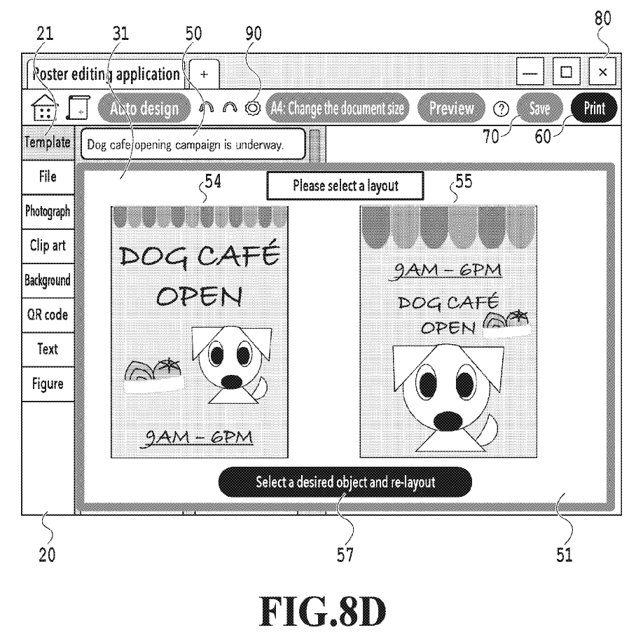

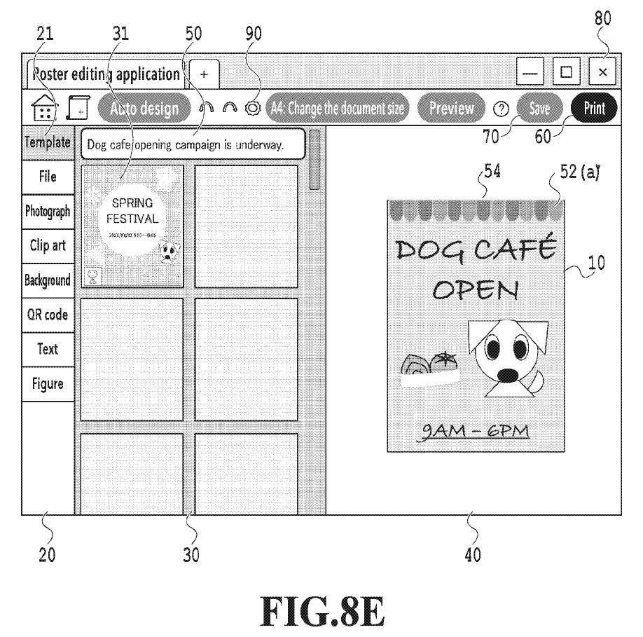

Regeneration of a layout proposal based on objects selected by the user, which is a feature of the present embodiment, will be described by using a flowchart of FIG. 7 and examples of UI screens of FIGS. 8A to 8E. In the layout proposal regeneration processing of the present embodiment, a plurality of new layout proposals are generated based on objects selected by the user, and the user is asked to select a layout to be an editing target from the plurality of new layout proposals. Here, like Embodiment 1, as shown in FIG. 8A, a case where two kinds of layout proposals, which were generated by the generative AI model 124 with "Dog cafe opening campaign is underway." as an input prompt, have been initially generated will be described as an example. The processing of the flowchart of FIG. 7 is started in response to the pressing down of the "Select a desired object and re-layout" button 57 by the user without selecting a specific layout proposal from layout proposals 52 and 53 in a UI screen of FIG. 8A. Note that in the following description, sign "S" means a step.

In S701, the CPU 203 displays each object in a recognizable manner by applying a known image analysis technology to each displayed layout proposal, and so on, and receives a user selection on an object basis. FIG. 8B is a UI screen in which objects included in the layout proposals 52 and 53 in the display area 51 of FIG. 8A are indicated with boundary frames of dashed lines (52(a) to 52(g) and 53(a) to 53(f)) such that the user can recognize the respective objects. The user selects the objects 52(a) to 52(g) and 53(a) to 53(f) on an object basis via the UI screen in which each object can be recognized as shown in FIG. 8B. In this event, a selected object may be highlighted such that the user can grasp which object the user has selected. FIG. 8C shows an example of the highlight in a case where the objects 52(a), 52(b), 52(d), and 52(e) have been selected from the layout proposal 52 and the objects 53(d) and 53(f) have been selected from the layout proposal 53. Then, in a case where the user has selected any objects via the input device 117, a "Re-layout" button 58 is displayed in the lower portion of the display area 51. This "Re-layout" button 58 is a button for the user to instruct generation of a new layout proposal based on the selected objects at a stage where the user has completed the selection of all the objects. In addition, in the UI screen of FIG. 8C, there is also a button 91 for changing the generation number of layout proposals to be newly generated. The user can increment the default generation number (for example, "2") by pressing down a "+" button in the button 91, and can decrement the default generation number by pressing down a "-" button in the button 91.

In S702, the CPU 203 determines whether the object selection by the user has been completed. Specifically, the CPU 203 periodically checks the pressing down of the aforementioned "Re-layout" button 58, and proceeds to S703 at the timing at which the pressing down is detected. That is, until the pressing down of the "Re-layout" button 58 is detected, the CPU 203 returns to S701 and continues the processing of receiving the selection of an object.

In S703, the CPU 203 generates new layout proposals the number of which has been designated by the user (or the number of which has been set in default) based on all the objects selected by the user. The approach for generating a layout proposal is the same as S503 in the flowchart of FIG. 5 of Embodiment 1.

In S704, the CPU 203 displays, on the UI screen, the layout proposals newly generated in S703. Specifically, the CPU 203 causes the UI screen to transition from the state of FIG. 8C to the state of FIG. 8D. In the display area 51 of the UI screen of FIG. 8D, the two newly generated layout proposals 54 and 55 are displayed.

In S705, the CPU 203 switches processing to be executed next based on a user operation on the displayed UI screen. Specifically, in a case where the detected user operation is an operation of selecting a specific layout proposal from one or a plurality of layout proposals displayed in S704, the CPU 203 proceeds to S706. On the other hand, in a case where the detected user operation is not an operation of selecting a specific layout proposal, but an instruction to generate a new layout proposal again by using any objects in the layout proposals, the CPU 203 returns to S701. For example, in a case where the user has performed an operation of selecting the layout proposal 54 or 55 in the UI screen of aforementioned FIG. 8D, the CPU 203 proceeds to S706. On the other hand, in a case where the user has pressed down the "Select a desired object and re-layout" button 57, the CPU 203 returns to S701 to receive an operation of selecting an object, and continues the processing in and after S702.

In S706, the CPU 203 sets the layout proposal according to the user selection as an editing processing target. Specifically, the CPU 203 obtains data of the layout proposal according to the user selection from the server 120, and displays the layout proposal in the editing area 40. FIG. 8E shows a UI screen in a case where the user has selected the layout proposal 54 from the display area 51, and the UI screen transitions from the state of FIG. 8D to such a UI screen. After the setting of the layout proposal to be used as the editing processing target is completed, the CPU 203 exits the present processing, and returns to the flowchart of FIG. 3. The above is the content of the layout proposal regeneration processing according to the present embodiment.

### Modification

In the present embodiment, the number of layout proposals to be generated based on the object selection is designated by the user manually via the button 91; however, the configuration is not limited to this. For example, the number of layout proposals to be generated may be determined dynamically, for example, such that the larger the number of selected objects is, the larger the number of layout proposals to be generated is, in accordance with the number, types, and the like of selected objects at the time point at which the "Re-layout" button 58 is pressed down.

As described above, according to the present embodiment, the user can repeat the generation of a layout proposal based on the object selection until the user obtains a layout desired by the user. In this way, a user convenience in layout design of contents using a generative AI is improved.

### THIRD EMBODIMENT

In Embodiments 1 and 2, a new layout proposal is generated by using a selected object. Next, an aspect to generate a new layout proposal by also using a similar object to a selected object will be described as Embodiment 3. Note that in the following description, the description of contents common with the aforementioned Embodiments 1 and 2 will be omitted, and layout proposal regeneration processing which is a difference from Embodiments 1 and 2 will be described. In addition, in terms of the same configurations as in Embodiments 1 and 2, the same signs are added, or the same names are used, so that the description thereof is omitted as appropriate.

### Detail of Layout Proposal Regeneration Processing

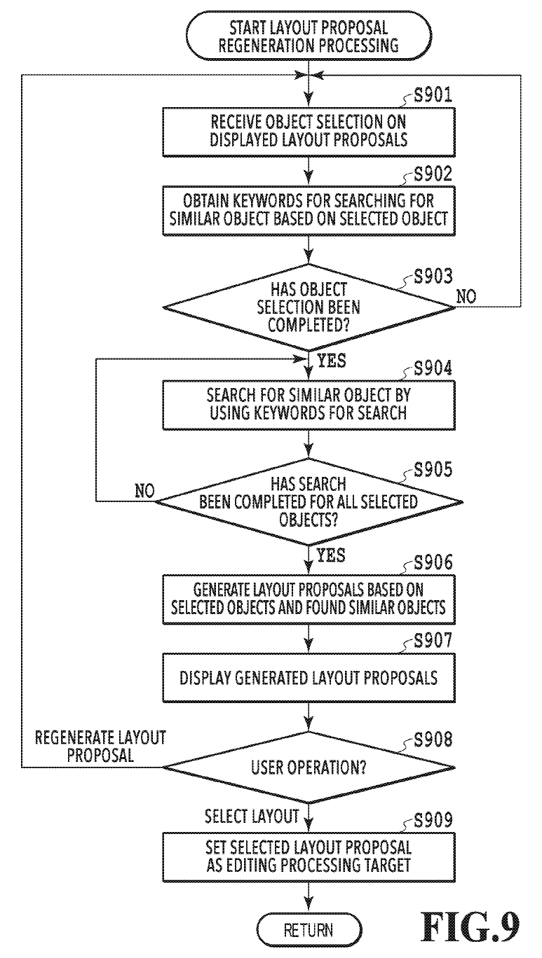

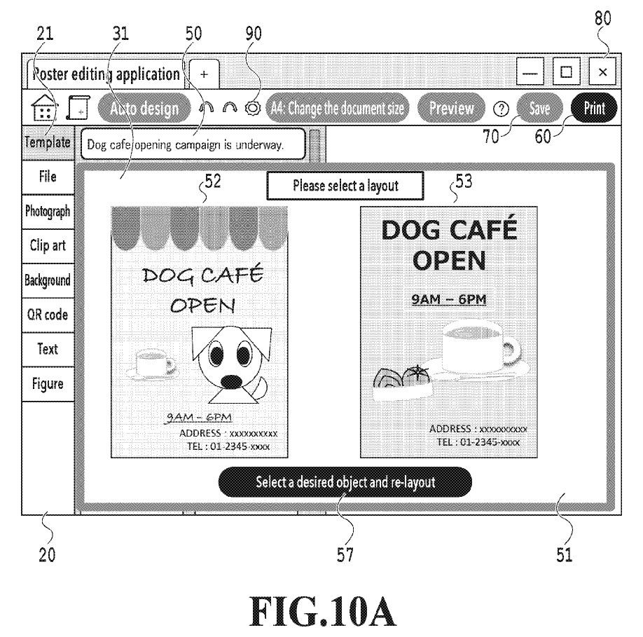

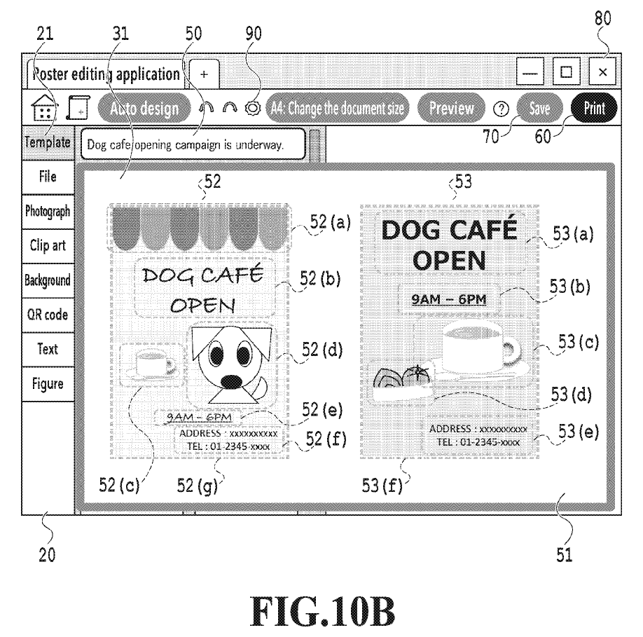

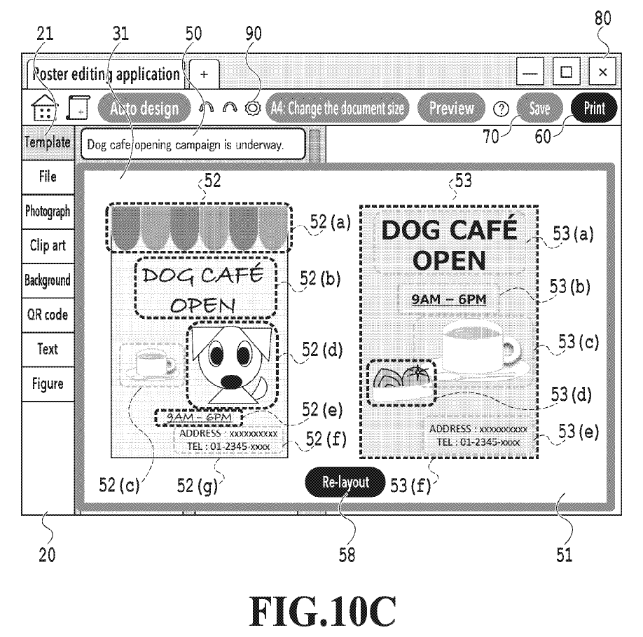

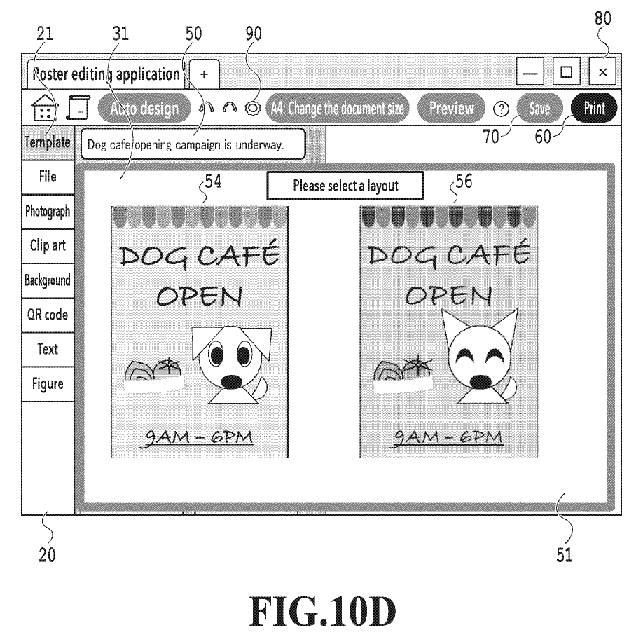

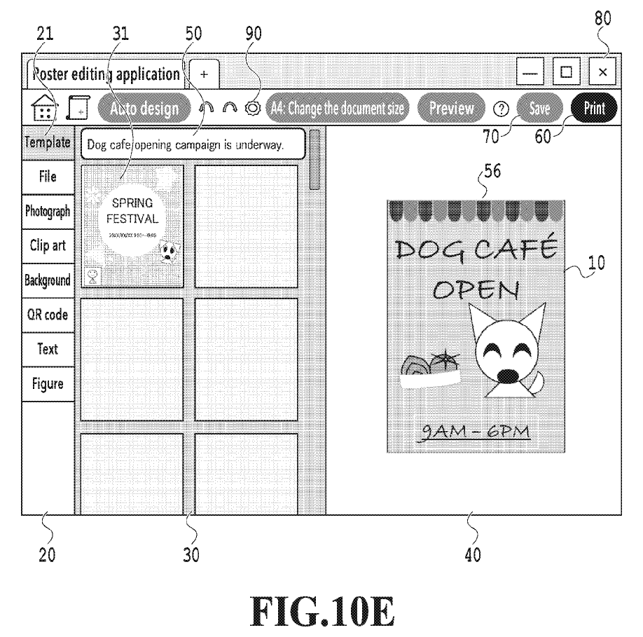

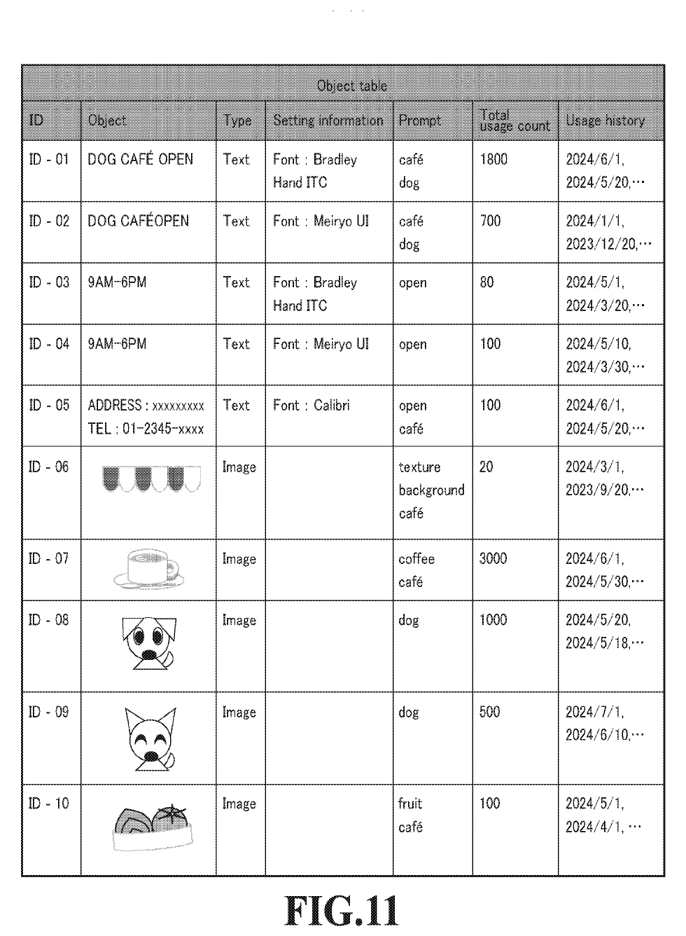

Regeneration of a layout proposal based on objects selected by the user, which is a feature of the present embodiment, will be described by using a flowchart of FIG. 9, examples of UI screens of FIGS. 10A to 10E, and an object table of FIG. 11. In the layout proposal regeneration processing of the present embodiment, a layout proposal is regenerated and presented based on a selected object and a similar object to the selected object. The flowchart of FIG. 9 is based on the flowchart of FIG. 7 of Embodiment 2. Here, like Embodiments 1 and 2, as shown in FIG. 10A, a case where two kinds of layout proposals, which were generated by the generative AI model 124 with "Dog cafe opening campaign is underway." as an input prompt, have been initially generated will be described as an example. The processing of the flowchart of FIG. 9 is started in response to the pressing down of the "Select a desired object and re-layout" button 57 by the user without selecting a specific layout proposal from layout proposals 52 and 53 in the UI screen of FIG. 10A. Note that in the following description, sign "S" means a step.

In S901, the CPU 203 displays each object in a recognizable manner by applying a known image analysis technology to each displayed layout proposal, and so on, and receives a user selection on an object basis. FIG. 10B is a UI screen in which objects included in the layout proposals 52 and 53 in the display area 51 of FIG. 10A are indicated with boundary frames of dashed lines (52(a) to 52(g) and 53(a) to 53(f)) such that the user can recognize the respective objects. The user selects the objects 52(a) to 52(g) and 53(a) to 53(f) on an object basis via the UI screen in which each object can be recognized as shown in FIG. 10B. In this event, a selected object may be highlighted such that the user can grasp which object the user has selected. FIG. 10C shows an example of the highlight in a case where the objects 52(a), 52(b), 52(d), and 52(e) have been selected from the layout proposal 52 and the objects 53(d) and 53(f) have been selected from the layout proposal 53. Then, in a case where the user has selected any object via the input device 117, a "Re-layout" button 58 is displayed in the lower portion of the display area 51. This "Re-layout" button 58 is a button for the user to instruct generation of a new layout proposal based on the objects according to the selection at a stage where the user has completed the selection of all the objects.

In S902, in terms of the object according to the user selection received in S901, the CPU 203 obtains keywords relevant to the object according to the user selection for searching for a similar object. In the present embodiment, as keywords, the CPU 203 obtains information of a prompt corresponding to the selected object and the type of the selected object by referring to the object table as shown in FIG. 11. In the object table of FIG. 11, various pieces of information such as ID, content, type, additional information (the font, the color, and the like in the case of a text object), prompt, usage count, usage history (date, time, and the like) are stored for each object. In this object table, every time the generative AI model 124 generates a layout proposal based on an input prompt in S304, for example, the above-described various pieces of information for an object included in the layout proposal are added or updated. The type, additional information, and the like of an object may be extracted by performing image analysis or the like on a generated layout proposal. Now, in the case of the object 52(d) selected in the UI screen of FIG. 10C as an example, "prompt: dog, type: image" are obtained as keywords. Note that the keywords may be obtained from attribute information added to each object in advance, or keywords generated by a generative AI (for example, "ChatGPT" or the like) along with the object selection may be obtained. Information of the obtained keywords is associated with the selected object and held in the RAM 205.

In S903, the CPU 203 determines whether the object selection by the user has been completed. Specifically, the CPU 203 periodically checks the pressing down of the aforementioned "Re-layout" button 58, and proceeds to S904 at the timing at which the pressing down is detected. That is, until the pressing down of the "Re-layout" button 58 is detected, the CPU 203 returns to S901, and continues the processing of receiving the selection of an object. Note that the user can release the selection by performing the selecting operation again on the selected object.

In S904, the CPU 203 searches for an object similar to each selected object by using the keywords obtained for each selected object in S902. Specifically, by referring to the object table as shown in FIG. 11, the CPU 203 finds an object whose keywords coincide from the existing objects in the table. The CPU 203 collates the contents of "prompt" and "type" obtained as keywords in S902 with the contents of description in the "prompt" field and the "type" field of the object table of FIG. 11, and if there is an object whose keywords coincide, the CPU 203 obtains data of the object. Now, "prompt: dog, type: image" have been obtained as keywords. In this case, first, texts having object IDs of "ID-01" and "ID-02" and images having object IDs of "ID-08" and "ID-09" whose prompt "dog" coincides are specified. Moreover, the images having object IDs of "ID-08" and "ID-09" whose type "image" coincides are specified. Here, the image of "ID-08" is the same as the image of the object 52(d) selected by the user in S902 (that is, the original image). Hence, data of the texts having object IDs of "ID-01" and "ID-02" and the image having object ID of "ID-09" are eventually obtained. Note that in the present embodiment, the search for a similar object is executed after the selection of all the objects is completed and the pressing down of the "Re-layout" button 58 is detected; however, the configuration is not limited to this. For example, the search for a similar object may be executed as background processing in response to the reception of the object selection by the user in S901.

In S905, the CPU 203 determines whether the search processing for similar objects in terms of all the objects selected by the user has been completed. If the search processing has been completed, the CPU 203 proceeds to S906. On the other hand, if there is any selected object which has not been subjected to the search processing yet, the CPU 203 returns to S904, and continues the processing.

In S906, the CPU 203 generates new layout proposals based on the objects according to the user selection received in S901 and the similar objects found by the search in and S904. The approach for generating a layout proposal is the same as S503 in the flowchart of FIG. 5 of Embodiment 1.

In S907, the CPU 203 displays, on the UI screen, the layout proposals newly generated in S906. Specifically, the CPU 203 causes the UI screen to transition from the state of FIG. 10C to the state of FIG. 10D. In the display area 51 of the UI screen of FIG. 10D, newly generated two layout proposals 54 and 56 are displayed.

In S908, the CPU 203 switches processing to be executed next based on a user operation on the displayed UI screen. Specifically, in a case where the detected user operation is an operation of selecting a specific layout proposal from one or a plurality of layout proposals displayed in S907, the CPU 203 proceeds to S909. On the other hand, in a case where the detected user operation is not an operation of selecting a specific layout proposal, but an instruction to generate a new layout proposal again by using any objects in the layout proposals, the CPU 203 returns to S901. For example, in a case where the user has performed an operation of selecting the layout proposal 54 or 56 in the UI screen of aforementioned FIG. 10D, the CPU 203 proceeds to S909. On the other hand, in a case where the user has pressed down the "Select a desired object and re-layout" button 57, the CPU 203 returns to S901 to receive an operation of selecting an object, and continues the processing in and after S902.

In S909, the CPU 203 sets, as an editing processing target, the layout proposal according to the user selection. Specifically, the CPU 203 obtains data of the layout proposal according to the user selection from the server 120, and displays the layout proposal in the editing area 40. FIG. 10E shows a UI screen in a case where the user has selected the layout proposal 56 from the display area 51, and the UI screen transitions from the state of FIG. 10D to such a UI screen. After the setting of the layout proposal to be used as the editing processing target is completed, the CPU 203 exits the present processing, and returns to the flowchart of FIG. 3. The above is the content of the layout proposal regeneration processing according to the present embodiment.

As described above, according to the present embodiment, a new layout proposal is generated based on an object selected by the user and a similar object to the object, and the user can repeat the generation of a layout proposal until the user obtains a desired layout. In this way, a user convenience in layout design of contents using a generative AI is improved.

### FOURTH EMBODIMENT

In Embodiments 1 to 3, it is possible for the user to freely select any objects from among objects included in each layout proposal. Next, an aspect to display an operation guide for each type of objects in a case where the user selects the object, and allow the user to perform object selection for each type will be described as Embodiment 4. Note that in the following description, the description of contents common with the aforementioned Embodiments 1 to 3 will be omitted, and layout proposal regeneration processing which is a difference from Embodiments 1 to 3 will be described. In addition, in terms of the same configurations as in Embodiments 1 to 3, the same signs are added, or the same names are used, so that the description thereof is omitted as appropriate.

### Detail of Layout Proposal Regeneration Processing

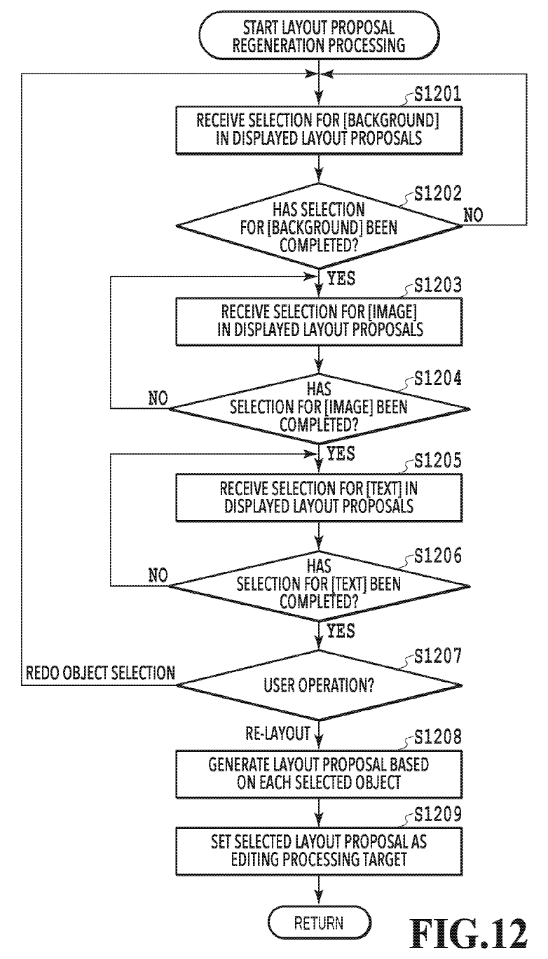

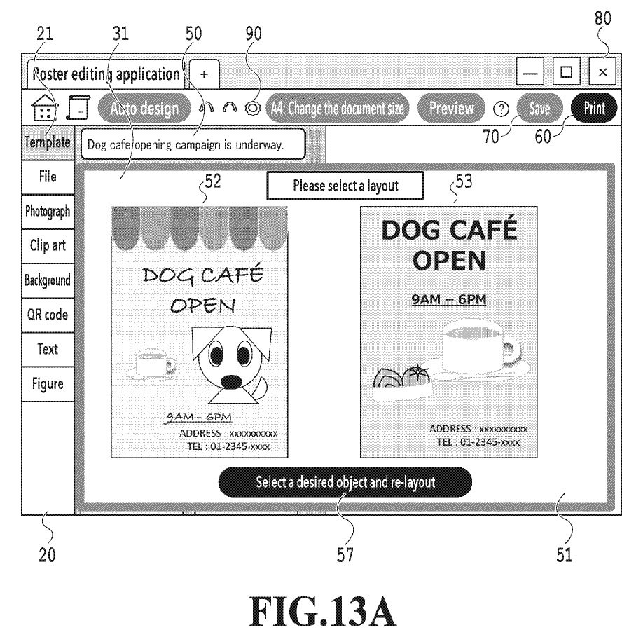

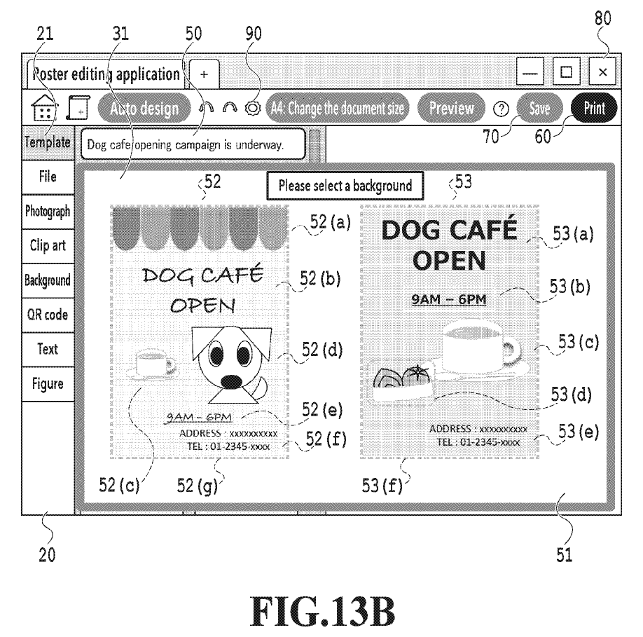

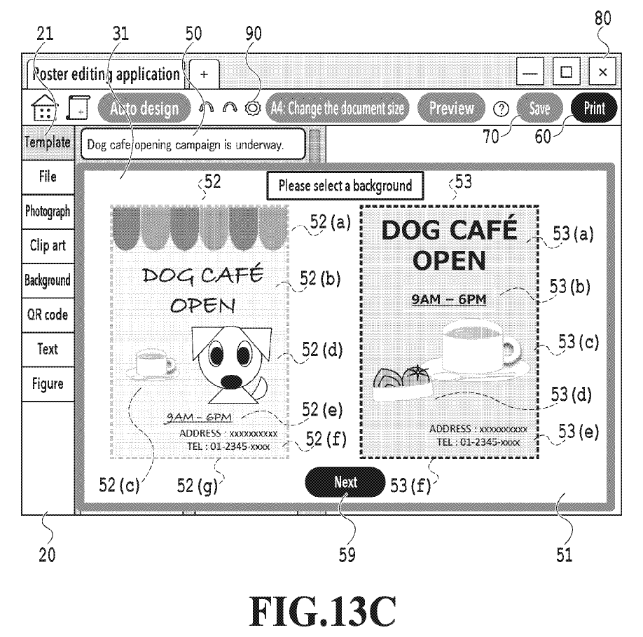

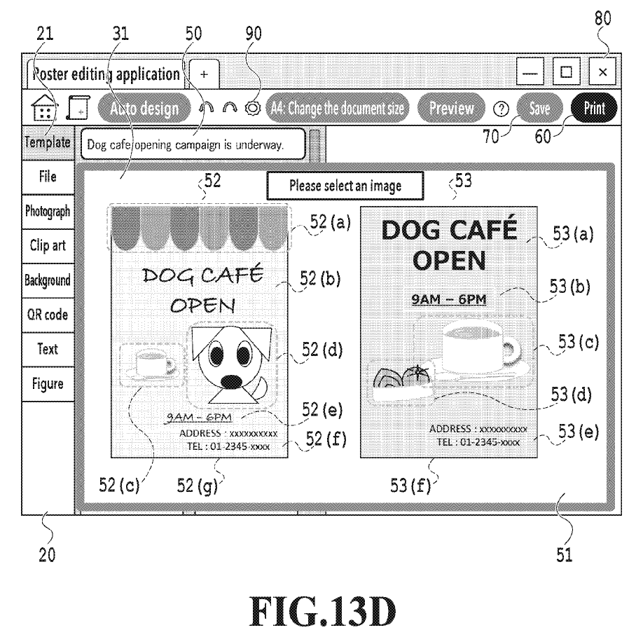

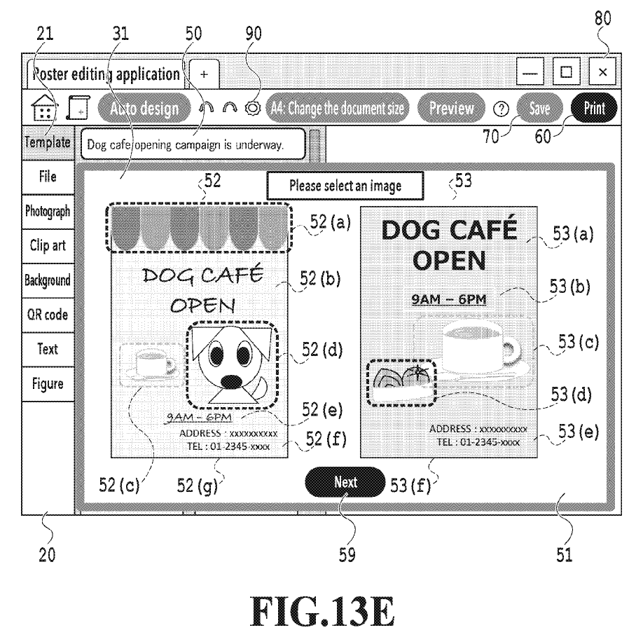

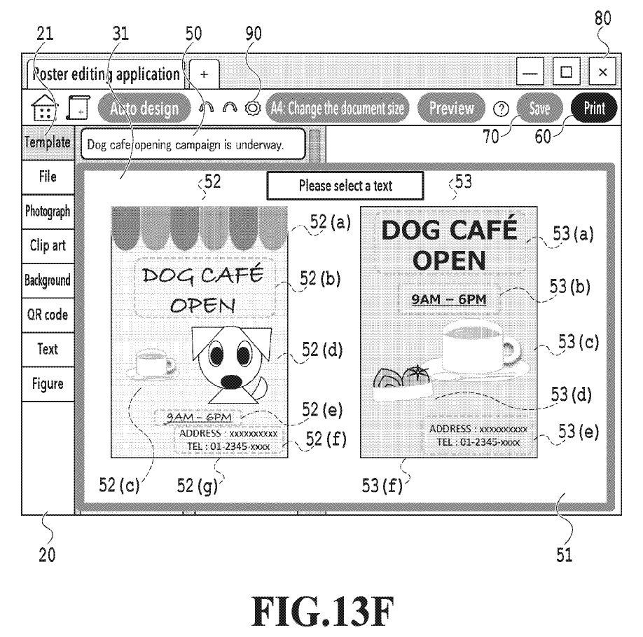

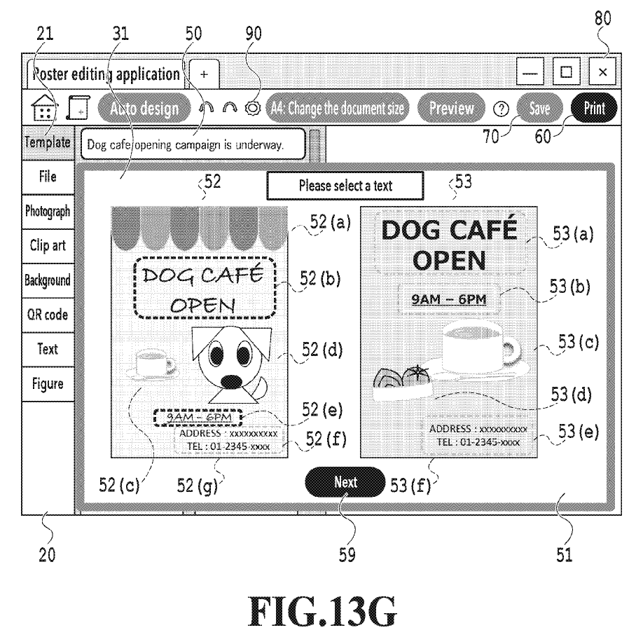

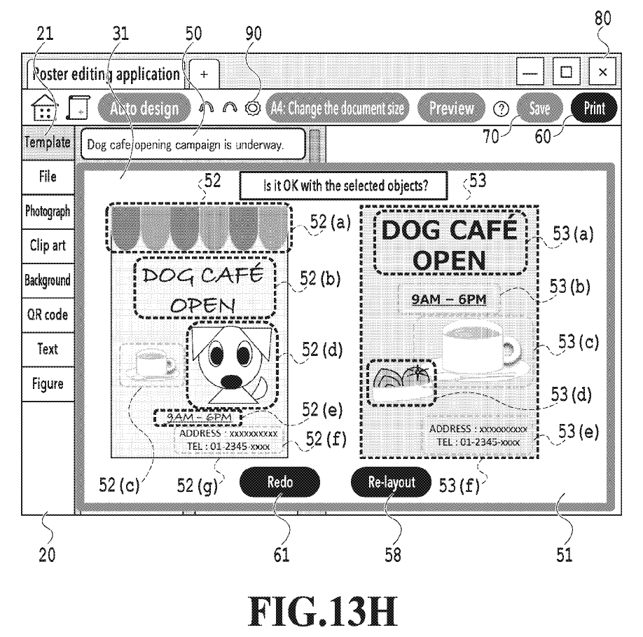

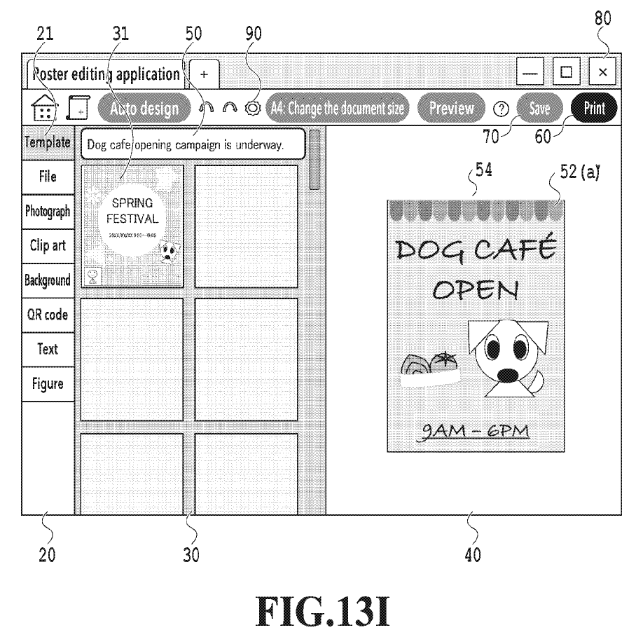

Regeneration of a layout proposal based on objects selected by the user, which is a feature of the present embodiment, will be described by using a flowchart of FIG. 12 and examples of UI screens of FIGS. 13A to 13I. In the layout proposal regeneration processing of the present embodiment, object selection from initially generated layout proposals is received for each "type" in sequence, and a layout proposal is regenerated based on selected objects and is presented. The flowchart of FIG. 12 is based on the flowchart of FIG. 5 of Embodiment 1. Here, like Embodiments 1 to 3, as shown in FIG. 13A, a case where two kinds of layout proposals, which were generated by the generative AI model 124 with "Dog cafe opening campaign is underway." as an input prompt, have been initially generated will be described as an example. The processing of the flowchart of FIG. 12 is started in response to the pressing down of the "Select a desired object and re-layout" button 57 by the user without selecting a specific layout proposal from layout proposals 52 and 53 in the UI screen of FIG. 13A. Note that in the following description, sign "S" means a step.

In S1201, the CPU 203 specifies each object by applying a known image analysis technology to each displayed layout proposal, and so on, and receives a selection for a type "background" among the objects included in each layout proposal. In this event, the CPU 203 causes the UI screen to transition from the state of FIG. 13B to the state of FIG. 13C. In the UI screen of FIG. 13B, a message "Please select a background" is displayed in the upper portion of the display area 51. Moreover, among the objects included in the layout proposals 52 and 53, the objects 52(g) and 53(f) showing objects of "background" in the layout proposals are displayed with boundary frames of dashed lines which indicate that the objects 52(g) and 53(f) can be selected. Via such a UI screen, the CPU 203 receives the selection of a "background" object by the user. FIG. 13C is a UI screen displayed in a case where the user has selected the "background" object 53(f) in the UI screen of FIG. 13B. Upon detecting a selecting operation of an object by the user, the CPU 203 highlights the "background" object according to the user selection, and displays a "Next" button 59 in the lower portion of the display area 51, as in the UI screen shown in FIG. 13C. This "Next" button 59 is a button for shifting to the subsequent selection for an object type.

In S1202, the CPU 203 determines whether the selection for the object type "background" has been completed. Specifically, the CPU 203 periodically checks the pressing down of the above-mentioned "Next" button 59, and proceeds to S1203 at the timing at which the pressing down is detected. That is, until the pressing down of the "Next" button 59 is detected, the CPU 203 continues the check processing.

In S1203, the CPU 203 receives selection for the type "image" among the objects included in each displayed layout proposal. In this event, the CPU 203 causes the UI screen to transition from the state of FIG. 13C to the state of FIG. 13D. In the UI screen of FIG. 13D, a message "Please select an image" is displayed in the upper portion of the display area 51. Moreover, among the objects included in the layout proposal 52, the objects 52(a), 52(c), and 52(d) showing objects of "image" are displayed with boundary frames of dashed lines which indicate that the objects 52(a), 52(c), and 52(d) can be selected. In addition, among the objects included in the layout proposal 53, the objects 53(c) and 53(d) showing objects of "image" are displayed with boundary frames of dashed lines which indicate that the objects 53(c) and 53(d) can be selected. Via such a UI screen, the CPU 203 receives the selection of an "image" object by the user. FIG. 13E is a UI screen displayed in a case where the user has selected the "image" objects 52(a), 52(d), and 53(d) in the UI screen of FIG. 13D. Upon detecting the selecting operation of an object by the user, the CPU 203 highlights the "image" objects according to the user selection, and displays the "Next" button 59 in the lower portion of the display area 51, as in the UI screen shown in FIG. 13E.

In S1204, the CPU 203 determines whether the selection for the object type "image" has been completed. Specifically, the CPU 203 periodically checks the pressing down of the above-mentioned "Next" button 59, and proceeds to S1205 at the timing at which the pressing down is detected. That is, until the pressing down of the "Next" button 59 is detected, the CPU 203 continues the check processing.

In S1205, the CPU 203 receives selection for the type "text" among the objects included in each displayed layout proposal. In this event, the CPU 203 causes the UI screen to transition from the state of FIG. 13E to the state of FIG. 13F. In the UI screen of FIG. 13F, a message "Please select a text" is displayed in the upper portion of the display area 51. Moreover, among the objects included in the layout proposal 52, the objects 52(b), 52(e), and 52(f) showing objects of "text" are displayed with boundary frames of dashed lines which indicate that the objects 52(b), 52(e), and 52(f) can be selected. In addition, among the objects included in the layout proposal 53, the objects 53(a), 53(b), and 53(e) showing objects of "text" are displayed with boundary frames of dashed lines which indicate that the objects 53(a), 53(b), and 53(e) can be selected. Via such a UI screen, the CPU 203 receives the selection of a "text" object by the user. FIG. 13G is a UI screen displayed in a case where the user has selected the "text" objects 52(b) and 52(e) in the UI screen of FIG. 13F. Upon detecting the selecting operation of objects by the user, the CPU 203 highlights the "text" objects according to the user selection, and displays the "Next" button 59 in the lower portion of the display area 51, as in the UI screen shown in FIG. 13G.

In S1206, the CPU 203 determines whether the selection for the object type "text" has been completed. Specifically, the CPU 203 periodically checks the pressing down of the above-mentioned "Next" button 59, and proceeds to S1207 at the timing at which the pressing down is detected. That is, until the pressing down of the "Next" button 59 is detected, the CPU 203 continues the check processing. In proceeding to S1207, the CPU 203 causes the UI screen to transition from the state of FIG. 13G to the state of FIG. 13H. In the UI screen of FIG. 13H, all the selected objects selected in the processing so far are highlighted, and a message "Is it OK with the selected objects?" is displayed in the upper portion of the display area 51, and further a "Re-layout" button 58 and a "Redo" button 61 are displayed in the lower portion of the display area 51. Here, the "Re-layout" button 58 is a button for the user to instruct generation of a new layout proposal based on the selected objects at a stage where the user has completed the object selection for all the object types. On the other hand, the "Redo" button 61 is a button for the user to redo the object selection from the beginning.

In S1207, the CPU 203 switches processing to be executed next based on a user operation on the displayed UI screen. Specifically, in a case where the detected user operation is the pressing down of the "Re-layout" button 58, the CPU 203 determines that the object selection for all the object types has been completed, and proceeds to S1208. On the other hand, in a case where the detected user operation is the pressing down of the "Redo" button 61, the CPU 203 returns to S1201, and redo the processing from the selection of a "background" object in the beginning.

In S1208, the CPU 203 generates a new layout proposal based on all the objects selected by the user. The approach for generating a layout proposal is the same as S503 in the flowchart of FIG. 5 of Embodiment 1.

In S1209, the CPU 203 sets, as an editing processing target, the layout proposal newly generated in S1208. Specifically, as shown in FIG. 13I, the CPU 203 displays the generated new layout proposal 54 in the editing area 40 on the UI screen and receives subsequent editing processing by the user. Note that in the UI screen of FIG. 13I, the object 52(a) selected from the layout proposal 52 has been resized to be smaller like an object 52(a') by interpolation processing in conformity to the new layout proposal. After the setting of the layout proposal to be used as the editing processing target is completed, the CPU 203 exits the present processing, and returns to the flowchart of FIG. 3.

The above is the content of the layout proposal regeneration processing according to the present embodiment. Note that in the above-mentioned embodiment, the description has been made by giving "background", "image", and "text" as examples of object types of selection targets, the configuration is not limited to this. For example, another object type (for example, illustration or the like) may be added, or only "image" and "text" may be set as selection targets.

As described above, according to the present embodiment, it becomes possible to receive, for each object type, selection of objects by the user in sequence from among a plurality of layout proposals, and to cause the generative AI to generate a new layout proposal including desired objects. This improves an operability at the time of selecting objects, and makes it possible to regenerate a new layout including desired objects.

The embodiments including the aforementioned Modifications can be combined as appropriate to be applied, and the Web application 121 may have some or all of the functions of the embodiments including the aforementioned Modifications.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

According to the present disclosure, it is possible to increase the degree of freedom at the time of editing by a user in a layout design of contents and to thus improve the convenience.

This application claims the benefit of Japanese Patent Application No. 2025-073760, filed Apr. 25, 2025, which is hereby incorporated by reference herein in its entirety.

What is claimed is:

1. A non-transitory computer readable storage medium storing a program for causing a computer to generate a layout of contents by executing the following processing:
causing a display device to display a plurality of first layout proposals relating to the contents;
receiving a user selection for a specific object among objects included in each of the plurality of first layout proposals; and
generating a second layout proposal of the contents based on the specific object according to the user selection.

2. The storage medium according to claim 1, wherein
the user selection is received via a user interface screen in which the objects included in each of the plurality of first layout proposals are displayed in a recognizable manner.

3. The storage medium according to claim 2, wherein
in the user interface screen, the objects are displayed in a recognizable manner with boundary frames surrounding each of the objects.

4. The storage medium according to claim 1, wherein
an adjustment of the objects included in the first layout proposals is performed in conformity to a framework of the second layout proposal to be generated.

5. The storage medium according to claim 1, further causing the computer to execute the following processing:
setting the generated second layout proposal as an editing target.

6. The storage medium according to claim 5, wherein
a plurality of the second layout proposals are generated, each of the second layout proposals differing from the other second layout proposal in the arrangement of the specific object according to the user selection, and
the computer is further caused to execute the following processing:
causing the display device to display the plurality of second layout proposals generated; and
setting, as the editing target, the second layout proposal selected by the user among the plurality of second layout proposals.

7. The storage medium according to claim 6, wherein
the number of the second layout proposals to be generated is determined in accordance with the number of the specific objects according to the user selection.

8. The storage medium according to claim 7, wherein
the number of the second layout proposals to be generated is determined such that the larger the number of the specific objects according to the user selection is, the larger the number of the second layout proposals to be generated is.

9. The storage medium according to claim 6, wherein
receiving the user selection, generating second layout proposals of the contents, and causing the display device to display the plurality of generated second layout proposals are configured to be repeatable.

10. The storage medium according to claim 1, wherein
the second layout proposal is generated based on the specific object according to the user selection and a similar object to the specific object.

11. The storage medium according to claim 10, further causing the computer to execute the following processing:
obtaining a keyword relevant to the specific object according to the user selection; and
searching for the similar object based on the obtained keyword, wherein
the second layout proposal is generated based on the specific object according to the user selection and the similar object found in the searching.

12. The storage medium according to claim 1, wherein
the user selection is received for each type of objects.

13. The storage medium according to claim 1, wherein
the second layout proposal is generated by a generative AI.

14. The storage medium according to claim 1, further causing the computer to execute the following processing:
generating a plurality of the first layout proposals, wherein
the plurality of generated first layout proposals are displayed on the display device.

15. The storage medium according to claim 14, wherein
the first layout proposals are generated by a generative AI.

16. An information processing apparatus for generating a layout of contents, comprising:
one or more memories storing instructions; and
one or more processors executing the instructions to:
cause a display device to display a plurality of first layout proposals relating to the contents;
receive a user selection for a specific object among objects included in each of the plurality of first layout proposals; and
generate a second layout proposal of the contents based on the specific object according to the user selection.

17. An information processing method for generating a layout of contents, the information processing method comprising causing a computer to execute the following processing:
causing a display device to display a plurality of first layout proposals relating to the contents;
receiving a user selection for a specific object among objects included in each of the plurality of first layout proposals; and
generating a second layout proposal of the contents based on the specific object according to the user selection.
